(19) United States
(12) Patent Application Publication
(10) Pub. No.: US 2006/0093283 A1
(43) Pub. Date: May 4, 2006

(54) Electro-optical subassembly

(76) Inventors: Adrianus J.P. van Haasteren, Loveland, CO (US); Alvin Tze Yen Lim, Loveland, CO (US); Frank J. Flens, Loveland, CO (US); Tom Sheau Tung Wong, Loveland, CO (US)

Correspondence Address: AGILENT TECHNOLOGIES, INC.;Intellectual Property Administration, Legal Department, DL 429, P.O. Box 7599, Loveland, CO, 80537-0599, US

(21) Appl. No.: 11/082,623

(22) Filed: Mar. 17, 2005

Related U.S. Application Data
(63) Continuation-in-part of application No. 10/904,224, filed on Oct. 29, 2004.

(51) Int. Cl. G02B 6/42

(52) U.S. Cl. 385/92

(57) ABSTRACT

An electro-optical subassembly formed using an optical unit and a base. The optical unit has a lens and a cavity in communication with the lens, the cavity having surfaces aligned with the lens. The base includes a body, shaped to fit within the cavity so as to have a predetermined alignment with the lens, and a plurality of leads embedded in and extending from the body. At least one end of one lead is positioned behind the lens when the base is inserted into the cavity and supports an electro-optical component that is aligned to the lens when the base is inserted into the optical unit.

### CROSS-REFERENCE TO RELATED APPLICATIONS

This application is a Continuation-in-Part of, and claims priority to, U.S. patent application Ser. No. 10/904,224 entitled ELECTRO-OPTICAL SUBASSEMBLY filed Oct. 29, 2004.

### BACKGROUND OF THE INVENTION

Electro-Optical (EO) components, such as lasers and photodiodes, are utilized in transmitters and receivers in fiber communication and usually packaged utilizing the transistor outline can (commonly referred to as a “TO can”). The EO components inside a TO can are wire-bonded to a number of leads that protrude through the package and permit signals to be routed to or from the EO components. These leads are bent and soldered onto a PCB board that contains the electronic components and circuitry to e.g. drive the laser or to amplify the signal generated by the photodiode.

A TO can has several disadvantages. The leads, typically a few millimeters in length, cause a degradation of the signals that are carried to and from the EO components. The leads also have to be bent and soldered onto the PCB board. This process is difficult to automate and is therefore typically performed by hand. Another disadvantage is the stack up of mechanical tolerances, e.g. the accuracy of the lens placement relative to laser and fiber is affected by mechanical tolerance of the die placement to the header, mechanical tolerances of the various piece parts, as well as the lens position in the TO can. Because of this tolerance stack-up three dedicated alignment systems are usually utilized in production (one for die placement; one for lens/can to die placement; and one for receptacle to lens), resulting in increased costs and lower throughput.

The present inventors have recognized a need for an electro-optical subassembly that eliminates some of the disadvantages of the TO can style subassembly.

### BRIEF DESCRIPTION OF THE DRAWINGS

An understanding of the present invention can be gained from the following detailed description of the invention, taken in conjunction with the accompanying drawings of which:

FIG. 1 is an isometric view of an electro-optical subassembly in accordance with an embodiment of the present invention.

FIG. 2 is a plan view of a lead frame in accordance with an embodiment of the present invention.

FIG. 3a is a plan view of a partial lead frame in accordance with an embodiment of the present invention.

FIG. 3b is a plan view of a partial lead frame in accordance with an embodiment of the present invention.

FIG. 4 is a plan view of a partial lead frame with molded features in accordance with an embodiment of the present invention.

FIG. 5 is an isometric view of a partial lead frame with molded features in accordance with an embodiment of the present invention.

FIG. 6 is an isometric view of an optical unit in accordance with an embodiment of the present invention.

FIG. 7a is a plan view of an optical unit in accordance with an embodiment of the present invention.

FIG. 7b is a sectional side view of an optical unit in accordance with an embodiment of the present invention.

FIG. 7c is a sectional side view of an optical unit in accordance with an embodiment of the present invention.

### DETAILED DESCRIPTION

Reference will now be made in detail to the present invention, examples of which are illustrated in the accompanying drawings, wherein like reference numerals refer to like elements throughout. In the description contained hereinafter, the use of a lowercase “n” adjacent to an element identifier denotes a non-specific instance of the element rather than a specific instance identified using a non-italicized letter adjacent to the element number or the general collection of all instances discussed using the element number by itself with a letter modifier.

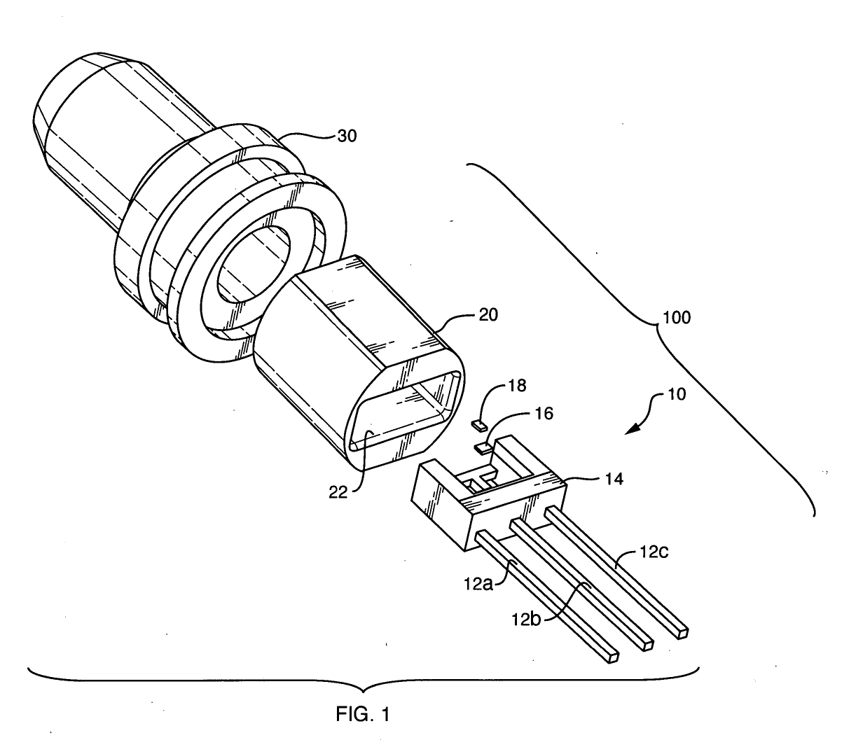

FIG. 1 is an isometric view of an electro-optical subassembly 100 in accordance with an embodiment of the present invention. The electro-optical assembly 100 generally comprises a base 10 and an optical unit 20. The base 10 generally comprises a collection of leads 12 partially encased by a molded body 14. The molded body provides mating surfaces to the optical unit 20. Electro-optical components, such as a photodiode 16 and a laser 18, are attached to one or more leads 12n, taking reference from the mating/datum surfaces. The optical unit 20 has a cavity 22 that accepts the base 10 and provides the opportunity for alignment of electro-optical components (such as 16 and 18) to an optical lens (not shown) through the mating/datum surfaces. The cavity is just one way to provide molded mating features that are accurately aligned to the lens. The optical lens may be formed as part of the optical unit 20 or seated in place. The electro-optical subassembly 100 mates with a port 30 that facilitates alignment of the optical unit 20 with an optical fiber (not shown).

The electro-optical assembly 100 provides many advantages. The base 10 can be manufactured using common techniques such as stamping or etching followed by epoxy over-molding. These processes are mature and amenable to mass production and more importantly provide high levels of precision. The leads 12 can be formed using standard technologies and, if desired, can be configured to facilitate surface mounting of the subassembly 100 onto a PCB board (not shown) thus shortening the signal path length, which in turn improves signal quality. The design of the base 10 allows the lens and the laser to share a common datum. The overall size of the electro optical subassembly 100 maybe reduced as well thus minimizing disruptive thermal expansions and as a result the use of polymer material for the manufacture of components such as the optical unit 20 and the base 10 becomes feasible. Further, as the leads 12 are anchored into the molded body 14, overall rigidity is increased. Accurate mating features can be created in the molded base and the molded optical unit to facilitate mutual alignment of lens and laser thus reducing the required number of alignment steps or axes like, for example, the alignment of port 30 to optical unit 20 in the direction of the optical axis of the lens. Alignment of the optical unit along a plane perpendicular to its optical axis and relative to the laser can also be made redundant via use of an interference fit between the optical unit 20 and the base 10. Alternatively, if highly accurate (sub micrometer) alignment between the optical unit 20 and laser 18 is required, the optical unit 20 can be aligned to the laser 18 before being attached by e.g. polymer laser welding.

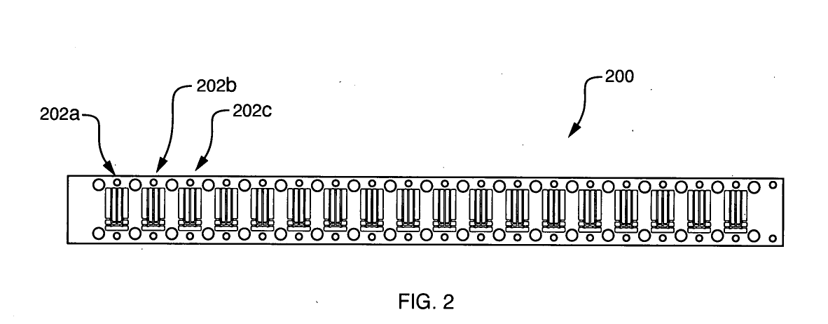

FIG. 2 is a plan view of a lead frame 200 in accordance with an embodiment of the present invention. The lead frame 200 generally comprises a rectangular copper sheet etched or stamped to form a plurality of lead sets 202.

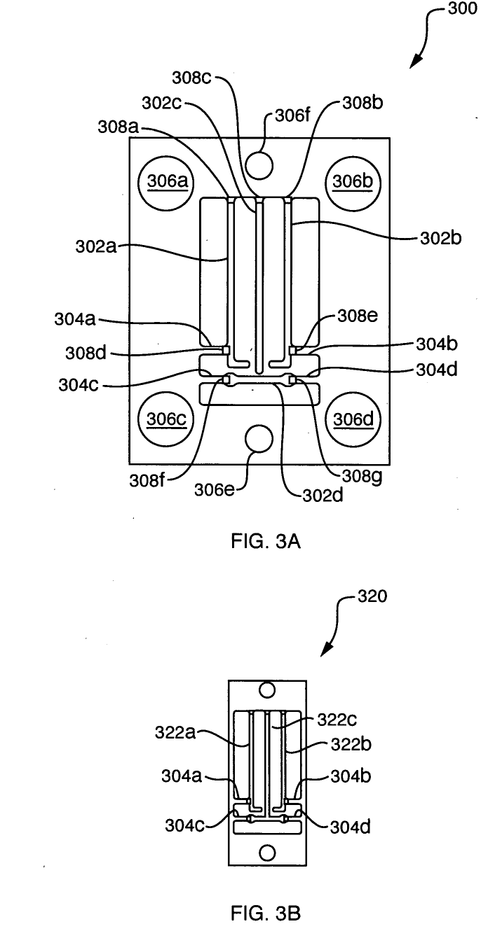

FIG. 3a is a plan view of a partial lead frame in accordance with an embodiment of the present invention. More specifically, FIG. 3a illustrates a single lead set 300 from the lead frame 200 illustrated in FIG. 2. The lead set 300 generally comprises four leads including two opposing “L” shaped leads 302a and 302b; a straight lead 302c extending between the opposing “L” shaped leads 302a and 302b; and a second straight lead 302d spaced from and perpendicular to the straight lead 302c. For added support during fabrication, detachable tie bars 304n are formed. In the example shown in FIG. 3a tie bar 304a supports lead 302a; tie bar 304b supports lead 302b; and tie bars 304c and 304d support lead 302d. After the body 14 is molded onto the leads 302n, the base 10 will be removed from the frame 300 at features 308. Features 308 are essentially weakened portions of the frame permitting the body 14 and leads 302 to be snapped out. A series of holes 306n are formed in the frame 200 to facilitate alignment and automation of the fabrication process.

One lead is required to hold e.g. an edge-emitting laser 18. The laser is connected to a driver IC through this lead and a separate second lead using e.g. wire bonds and/or electrically conductive epoxy. A third lead is required to hold a photodiode 16. This photodiode is connected to an amplifier through this lead and a fourth lead using e.g. wire bonds and/or electrically conductive epoxy. Depending on the design of the EO-components the laser and the detector can share a lead, thus reducing the number of required leads to three.

If the lead frame 300 is stamped, the central lead 302c may be formed lower relative to lead 302d. If the lead frame 300 is etched, post processing may lower the central lead 302c. In both cases, a surface sensitive monitor photodiode 16 can be placed behind and somewhat below the laser and as such will collect a fraction of the light emitted from the back facet of the laser 18. Where required it is possible to utilize a lens or mirror element to direct more light from a laser facet towards the monitor photodiode. Since the surfaces of photodiode and laser are now parallel to each other the complexity of the wire bonding is reduced as compared to that for a TO-can. Alternatively, an edge-sensitive photodiode can also be utilized by placing it directly behind the laser to allow the light emitted from the laser 18 back facet to impinge upon it.

FIG. 3a shows an example of a lead configuration in which laser 18 is thermally isolated from the printed circuit board assembly on which electro-optical subassembly 100 sits. The laser 18 is attached to an isolated cross bar 302d using e.g. an electrically conductive epoxy or a solder connection. The photodiode is attached to lead 302c also by use of an electrically conductive epoxy or solder and its top pad is wire bonded to, e.g., lead 302b. If the top pad of the laser has the same polarity as the top pad of the photodiode it is wire bonded to lead 302b with the cross bar 302d being wire bonded to lead 302a. If the laser top pad has the opposite polarity as compared to that of the photodiode its top pad is wire bonded to lead 302a with lead 302d being wire bonded to lead 302b. This design can therefore easily be adjusted for various laser designs while maintaining the functionality of the leads 302a, 302b, and 302c.

FIG. 3b is a plan view of a partial lead frame 320 in accordance with another embodiment of the present invention. The lead frame 320 has three leads: an “L” lead 322a; an opposing “L” shaped lead 322b; and an inverted “T” shaped lead 322c extending between the opposing “L” shaped leads 322a and 322b. The configuration in FIG. 3b is only suitable for lasers and photodiodes that have bottom pads with a common polarity. This configuration provides an efficient thermal path to the PCB upon which the unit is mounted.

To provide some context regarding the dimensional benefits possible with the present invention, a set of example dimensions will be provided. In no way is the recitation of these dimensions intended to limit the scope of the claimed invention to the stated sizes. By way of example, the overall dimension of the cut out section forming the lead frames 202n is 6.4 mm wide and 12 mm long. It is to be noted that the leads can be easily shortened depending on the requirements of the application. The leads 302n are approximately 0.5 mm wide with a 1 mm gap between the vertical portions of the leads. The lead spacing of 1 mm drives the overall width. The limits of the spacing will vary depending on the capability of the stamping or etching house. A gap of 0.33 mm may be provided between the extensions of the “L” shaped leads and the central straight lead 302c. Similarly, a gap of 0.2 mm may be provided between the bottom of the central straight lead 302c and the horizontal straight lead 302d.

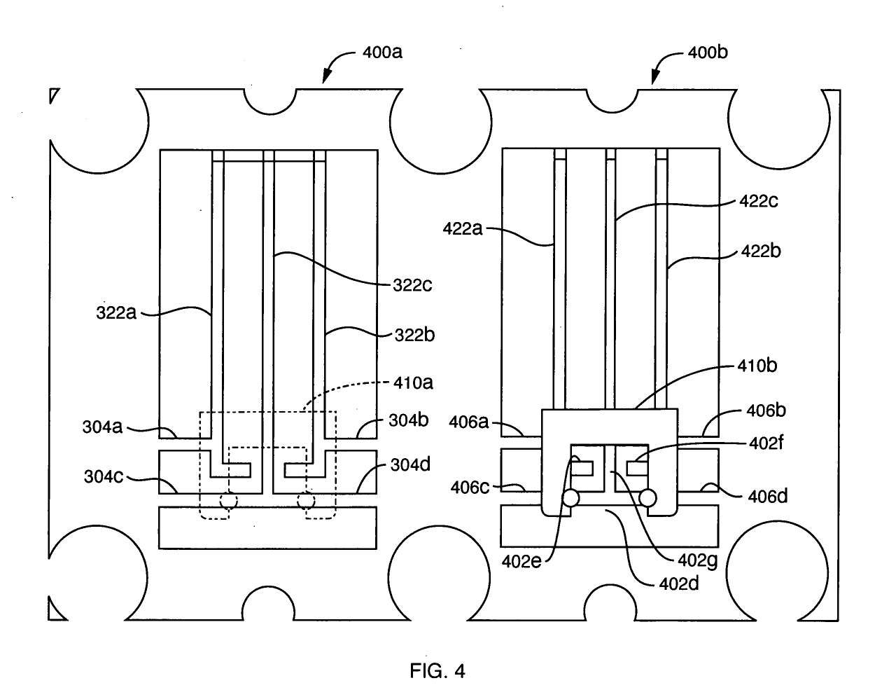

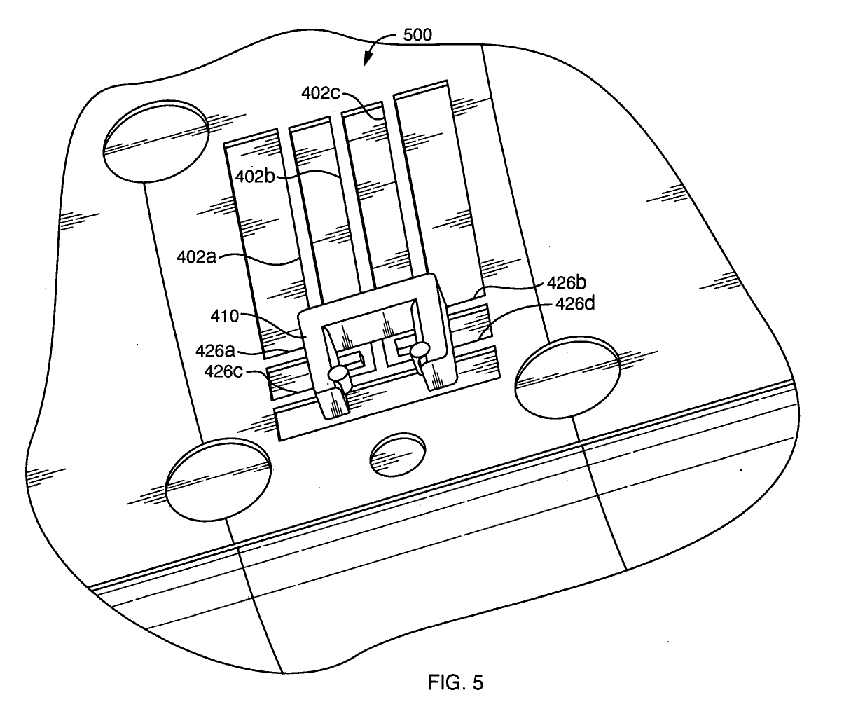

FIG. 4 is a three-dimensional plan view of a partial lead frame with molded features in accordance with an embodiment of the present invention. FIG. 5 is an isometric view of a partial lead frame with molded features in accordance with an embodiment of the present invention. FIG. 4 illustrates two lead frames 400a and 400b having bodies 410a and 410b molded thereon. In the example shown in 400a, the body 410a is rendered transparent to provide a more complete understanding of the invention. The bodies 410a and 410b may be formed of plastic or any other material capable of being molded around the leads while exhibiting low thermal expansion characteristics.

The lead frames 400a and 400b generally have the configuration illustrated in FIG. 3b. The bodies 410a and 410b are roughly “U” shaped with the arms of the U encompassing the ends of the leads 322a through 322c and 422a through 422c. The bodies 410a and 410b are open at the side of the short horizontal portion of the “T” shaped lead 322c and 422c respectively. It is through this open end that light may be directed towards or received from the lens of the optical unit 20. As all surfaces of the bodies 410n are potential mating surfaces to optical unit 20, the alignment of the laser 18 with these surfaces automatically assures accurate alignment of the laser to lens 604 upon insertion of the body into the lens cavity.

The surfaces of the bodies 410n may be used to pre-locate or mate with the surfaces of the cavity 22. It may prove beneficial to angle the outside edges of the bodies 410n to ease insertion into cavity 22. Controlling the vertical position of the leads with respect to the upper and lower surfaces of the bodies 410n, and the placement of the laser along the lead 304d the waveguide of the laser 18 can be accurately positioned relative to lens 604 when the electro-optical subassembly 100 is assembled.

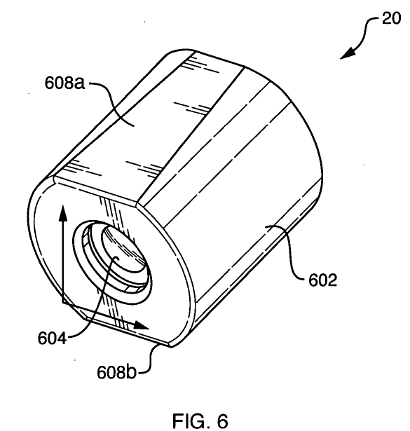

FIG. 6 is an isometric view of an optical unit 20 in accordance with an embodiment of the present invention. The optical unit 20 generally comprises a body portion 602 and a lens 604. The lens 604 can be integrated with the body 20 or inserted and attached. The body portion 602 has two opposing flat surfaces 608a and 608b. The lens 604 may comprise a-spherical surfaces. The exact design of the lens 604 will be determined by the required functionality, for example coupling the light from a laser into an optical fiber or coupling the light from an optical fiber to a photodiode. The opposing flat surfaces 608a and 608b may be molded or ground into the body.

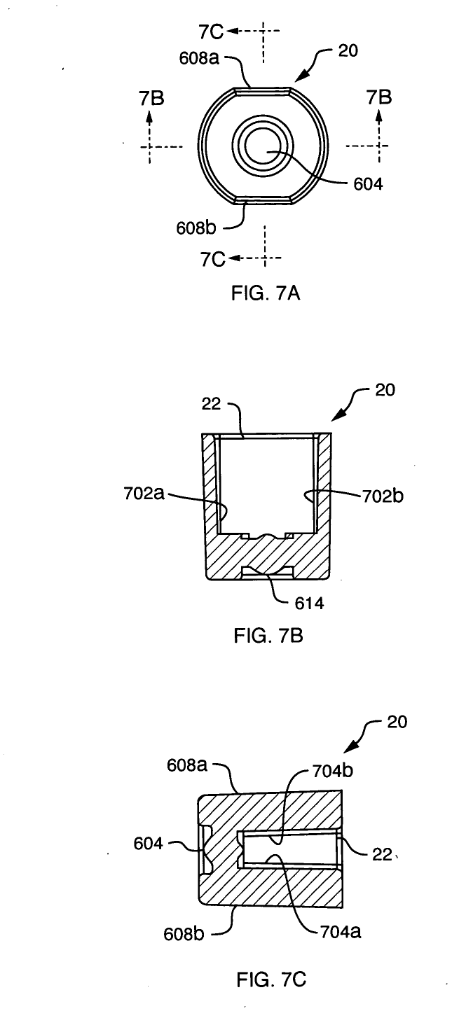

FIGS. 7a through 7c are views of an optical unit 20 in accordance with an embodiment of the present invention. The size of the optical unit 20 may vary. However, to provide some context regarding the dimensional benefits possible with the present invention, a set of example dimensions will be listed here. The recitation of these dimensions is not intended to limit the scope of the claimed invention to the stated sizes. The body 602 is generally cylindrical with a length of 5 mm. The body 602 has a diameter of 5 mm at the end 609. The external surface may be sloped relative to the optical axis of the optical unit 20, for example 1.5 degrees, to facilitate insertion into the port 30. Opposing flat portions 608a and 608b may be formed on the exterior surface for alignment with the port 30. The lens 604, as illustrated in the example, has an internal clear aperture of 0.8 mm and an external clear aperture of 1.5 mm. The lens 604 is 1.5 mm thick. The recess into which the lens 604 is formed has a diameter of 2 mm. The cavity 22, as illustrated in the example, is roughly 1.4 mm high, 4 mm wide, and 4 mm deep. The walls of the cavity may be sloped to facilitate insertion and alignment of the base 10 and should match the external dimensions of the base 10. Specifically, opposing flat surfaces 702a-702b and 704a-704b may be angled from the optical axis of the lens 604, for example 1.5 degrees.

In general, the shape of the cavity 22 and the body 14 should be configured to allow an end or edge of one or more leads (for example the leads 302d in FIG. 3a and the lead 322c in FIG. 3b) to reference against the lens 604 of the optical unit 20.

Although several embodiments of the present invention have been shown and described, it will be appreciated by those skilled in the art that changes may be made in these embodiments without departing from the principles and spirit of the invention, the scope of which is defined in the claims and their equivalents.

What is claimed is:

1. An electro-optical subassembly comprising:
an optical unit having a lens and alignment features provided by a cavity in communication with the lens;
a base including a body, shaped to allow an optical unit to mate so as to have a predetermined alignment, and a plurality of leads embedded in and extending from the body, wherein at least one end of one lead is positioned behind and along the optical axis of the lens when the base is inserted into the cavity;
an electro-optical component which is supported by at least one lead, and which is in alignment with the optical unit.

2. An electro-optical subassembly, as set forth in claim 1, wherein the base is generally U shaped.

3. An electro-optical subassembly, as set forth in claim 2, wherein the base is molded using a polymer.

4. An electro-optical subassembly, as set forth in claim 2, wherein the base comprises:
a cross member supporting two arms, wherein the arms of the base are inserted into the cavity such that the open portion of the base faces the lens.

5. An electro-optical subassembly, as set forth in claim 1, wherein the optical unit comprises:
an elongated body having a lens formed in one end and a cavity extending through the body to the lens, the elongated body being shaped to interface with an optical port.

6. An electro-optical subassembly, as set forth in claim 1, wherein the cavity is formed to offer mating/alignment features that facilitate alignment of the base with the lens.

7. An electro-optical subassembly, as set forth in claim 1, wherein the cavity has at least one flat surface extending at a slight angle to the optical axis of the lens.

8. An electro-optical subassembly, as set forth in claim 5, wherein the elongated body is generally cylinder shaped with at least one flat portion formed thereon.

9. An electro-optical subassembly comprising:
an optical unit having a body with a lens at a first end and a cavity extending from the lens to a second end;
a base having a body supporting a plurality of leads, the body being shaped to fit within the cavity so as to place the leads into a fixed position with respect to the lens; and
an electo-optical component supported by a lead so as to be in optical alignment with the lens.

10. An electro-optical subassembly, as set forth in claim 9, wherein the lens of the optical unit is formed as part of the body.

11. An electro-optical subassembly, as set forth in claim 9, wherein walls of the cavity are sloped to facilitate insertion of the base.

12. An electro-optical subassembly, as set forth in claim 9, wherein the body of the base is generally U-shaped.

13. An electro-optical subassembly, as set forth in claim 9, wherein the base is molded over the plurality of leads.

14. An electro-optical subassembly, as set forth in claim 13, wherein one of the plurality of leads is T shaped having first cross member extending between the arms of the U-shaped base and a second cross member extending from the first cross member through the base of the U.

15. An electro-optical subassembly, as set forth in claim 14, wherein the electro-optical component is a laser supported by the T shaped lead.

16. An electro-optical subassembly, as set forth in claim 15, wherein the T shaped lead is connected to the cathode or anode of the laser.

17. An electro-optical subassembly, as set forth in claim 15, wherein the T shaped lead also supports a photodiode such that some light emitted by the laser impinges on the photodiode's light sensitive area.

18. An electro-optical subassembly, as set forth in claim 17, wherein the T shaped lead is also connected to either the photodiode's cathode or anode.

19. An electro-optical subassembly, as set forth in claim 13, wherein a first lead connects the arms of the U-shaped base and a second lead extends through the bottom of the U-shaped base toward the first lead ending close to it.

20. An electro-optical subassembly, as set forth in claim 19, wherein the electro-optical component is a laser supported by the first lead.

21. An electro-optical subassembly, as set forth in claim 20, wherein the first and second lead are connected to the cathode and anode of the laser.

22. An electro-optical subassembly, as set forth in claim 21, wherein the second lead also supports a photodiode such that some light emitted by the laser impinges on the photodiode's light sensitive area.

23. An electro-optical subassembly, as set forth in claim 22, wherein the second lead is also connected to either the photodiodes cathode or anode.
